(19) United States
(12) Patent Application Publication
(10) Pub. No.: US 2004/0194425 A1
(43) Pub. Date: Oct. 7, 2004

(54) Method and apparatus used for constructing an arched shaped structure

(76) Inventors: Cathy D. Santa Cruz, Reno, NV (US); Wayne R. Sandstrom, Wadsworth, NV (US)

Correspondence Address: Cathy D. Santa Cruz, 7630 Tholl Drive, Reno, NV, 89506, US

(21) Appl. No.: 10/404,575

(22) Filed: Apr. 1, 2003

(51) Int. Cl. E06B 1/04

(52) U.S. Cl. 52/749.1

(57) ABSTRACT

An apparatus that is used for constructing an arched shaped structure, such as within passageways, walls, windows etc. The apparatus is of very simple construction and can be made at the worksite or it can be pre-manufactured and purchased in varying lengths, shapes or sizes. The overall apparatus consists of two main components, namely an elongated corrugated member having spacers provided therein and which can be bent to fit within a framework.

### FIELD OF THE INVENTION

The present invention relates in general to construction methods and devices used for facilitating construction of an arched shaped opening, such as used to form an archway within walls, doorframes, or any other structure which is to be arched, etc. However, the invention more particularly pertains to use of an elongated flexible corrugated member having upraised ridges interconnected by valleys with each of the valleys having a spacer therein. Thus, the novel elongated member and spacers in combination provide an apparatus that can be easily assembled, shaped and installed at the job site by a worker and eliminates the need for a pre-form, or the like. Also, the method for installation is very simple and can be easily performed by any worker having typical knowledge pertaining to general building construction, as no specialized skills are required.

### BACKGROUND OF THE INVENTION

Arch passageways, in general, undoubtedly date from earliest historic times. While the end product, i.e. arch-shaped passageway, cannot be characterized as novel, economic considerations dictate that the construction of arch-shaped passageways, which are now primarily constructed for aesthetic reasons, be accomplished by new and improved methods and/or new and improved materials and structures.

The known prior art contains many references to devices, structures, and methods for obtaining arch-shaped passageways. For example, U.S. Pat. Nos. 2,442,929, 2,005,572, 1,782,147, and 1,979,701 are directed to arch passageway construction in conjunction with plaster/lath construction that has become largely obsolete. Other prior art such as U.S. Pat. No. 2,064,704 teaches an arch passageway construction that is complicated and requires the assembling of a number of elements and is thus disadvantageous from the standpoint of labor costs. The deficiencies of the prior art primarily rest on the failure to provide arch passageway construction that is efficient, strong, capable of being formed into different types of shapes, and is very cost effective, such as taught within the present invention.

The construction of an archway has normally required the assembly of a wooden support at the construction site. Plywood is cut in a manner to provide the outline of the arch when completed. Two sections of plywood are separated by spacers so as to maintain the relative position of the two sections of plywood during affixation onto the adjacent studs and headers, whereby defining an unfinished opening. After affixation of the curved plywood form, it has been common practice to affix strips of drywall to support pieces serving as spacers. Since the objective is to form a continuously curved surface along the exposed face of the intermediate supports, the use of thin strips of drywall to form the exposed surface of the archway is made to approximate a curve. The process of affixation of the drywall strips is time consuming and not cost effective. In order to finish the irregular approximation of the desired arch curve, the use of a drywall compound in substantial thickness is normally required. Unfortunately, this construction process can result in a nonsymmetrical arch if great care is not taken.

In an attempt to overcome problems associated with the fabrication of an archway at the jobsite from the combination of contoured plywood, drywall and the intermediate support strips, prefabricated archways made from molded foamed plastics have been used. A prefabricated archway formed of molded polyethylene is described in U.S. Pat. No. 4,601,138 to Hampton wherein a relatively light weight arch can be brought to the location of the project and nailed or otherwise affixed directly to the framing of the adjacent wall. The prefabricated plastic archway is sized so as to provide an abutting relationship to the adjacent edges of the wall surfaces. The width from one outer surface to the opposing outer surface of the prefabricated archway is equal to the distance between the finished surfaces of the opposing walls. In other words, the arches are dimensioned to form a butt joint against the existing drywall or wallboard. The prefabricated archway is secured in place by a series of nails applied through the exposed surface of the foam into the studs and headers comprising the support members. Following affixation, conventional taping is applied to the seam between foam and adjacent drywall. In practice, the seam between adjacent drywall and the foam arch has been found to display cracking due in part to the use of dissimilar materials at the seam thereby requiring future repair and maintenance. Also, the subsequent movement of nail heads outwardly and away from the foam archway creates an unsightly appearance requiring further maintenance.

The problems mentioned above in connection with prefabricated archways formed of foamed plastic are addressed in U.S. Pat. No. 4,665,666 to Hampton wherein the use of drywall paper in the molding process is recommended. During the formation of the archway, the reference teaches lining the mold with drywall paper, which then becomes permanently bonded to the molded archway. As noted in the patent, the drywall paper strengthens the finished arch by adding a fibrous laminate to its exterior surface so as to reduce cracking. Furthermore, the use of the paper is intended to eliminate the “nail pops” occurring after installation. This modification to the construction of prefabricated archways is required because of the incompatibility of foamed plastic material with the wall-defining materials used in normal construction techniques. While the molded foam prefabricated archways accomplish the goal of eliminating the construction of coarse archway forms at the construction site, the problems arising from the use of a foamed material such as seam parting, cracking, nail popping and limited resistance to applied pressure remain.

### SUMMARY OF THE INVENTION

Accordingly, it is a primary object of the present invention to provide a durable archway that can be easily assembled, uniformly shaped into a desired form, and installed on site without the need for pre-forms or the like.

Another object of the present invention is to provide an apparatus that can be used for constructing an arched shaped structure that is not limited to a specific size or shape and allows the user to easily form an archway having a contour of their individual liking. This not only includes an arch shape but any curvature related thereto, including serpentine, oval, or the like.

Yet another object of the present invention is to provide an apparatus that can be used for constructing an arched shaped structure that can be made from simple pre-existing cost effective materials. For example, in the preferred embodiment the main apparatus consists of an elongated corrugated member such as corrugated steel and spacers made from wood, or the like.

Still another object of the present invention is to provide an apparatus that can be used for constructing an arched shaped structure that recognizes, addresses and resolves the afore mentioned drawbacks and associated disadvantages inherent within the known prior art.

Yet another object of the present invention is to provide an apparatus that can be used for constructing an arched shaped structure that is affixed directly to the wall support members so as to provide a base for the wallboard or drywall used on the adjacent wall.

Yet another object of the present invention is to provide an apparatus that can be used for constructing an arched shaped structure that can be installed quickly and easily and can be finished by conventional modern construction techniques. We also provide a simplified method of use and installation.

Other objects and advantages will become apparent when taken into consideration with the following specification and drawings.

### BRIEF DESCRIPTION OF THE DRAWINGS

FIG. 1 is substantially a plan overview of the preferred embodiment for the present invention.

FIG. 2 is substantially a partially enlarged side view of the apparatus of the present invention.

### DETAILED DESCRIPTION OF THE DRAWINGS

Referring now in detail to the drawings wherein like characters refer to like elements throughout the various views. The present invention includes use of an apparatus that can be used for constructing an arched shaped structure, such as within a doorway, a wall or the like. It is to be understood that various configurations of a workers choice can be created at the job site using the noted apparatus. Thus the invention is not to be limited to the configuration as depicted herein as this is only one possible configuration for exemplary purposes.

As depicted throughout the various views, (10) is substantially an overview of the present invention that is to be installed within a passageway such as within a pre-existing framework (12) which is substantially formed from first and second spaced apart vertical stud members (14) and interconnected by a typical header member or cross stud (16).

The present invention is very uncomplicated in construction and is simply formed from an elongated corrugated member (18) having upraised ridges (20) interconnected by valleys (22) with each of the valleys having a spacer (24) therein. It is to be noted elongated corrugated member (18) can be made from any suitable material of engineering choice. However, it has been found that a portion of a pre-existing sheet of corrugated steel is most efficient and conveniently shaped for ultimate function for the desired end use.

It is to be further noted that each of the spacers (24) can be made from any suitable material of engineering choice. However, it has been found that simple wooden blocks are most efficient and cost effective. Still further, it is to be understood that depending on the actual shape and size of each of the spacers (24) the angle of curvature is determined there from. For example, the wider the spacer is the amount of flexibility of the elongated corrugated member (18) is restricted or reduced, while the smaller the spacer is the amount of flexibility of the elongated corrugated member (18) is increased. Thus smaller spacers provide more curvature while larger spacers reduce the curvature. Therefore, the actual angle of curvature of elongated corrugated member (18) is determined by the size of each of the spacers (24). It is to be understood that various sized spacers (24) in combination can be used to create different styles of archways, depending on the needs or desires of the workman. It can also be seen that if different sizes of spacers (24) are used, not only can an archway be formed but other designs or configurations are possible as well, such as serpentine shapes or the like.

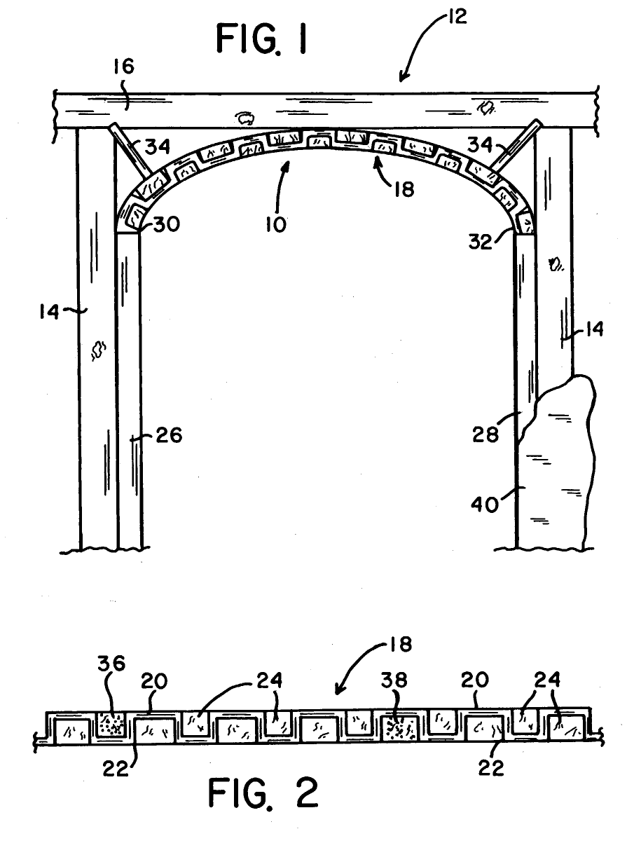

As depicted in FIG. 1, it can clearly be seen that the previously noted framework (12) further includes a first vertical support member (26) which is fixedly attached onto the first vertical stud, and a second vertical support member (28) which is fixedly attached onto the second vertical stud. It can further be seen that elongated corrugated member (18) with each of the spacers (24) in combination, when bent form a curved or arched shaped structure having a first end (30) and a second end (32). Thus, the arched shaped structure or elongated corrugated member (18) when bent can easily be positioned in between the first and second spaced apart vertical stud members (14) with the first end (30) being fixedly attached onto first vertical support member (26) and the second end (32) being fixedly attached onto second vertical support member (28). Whereby, elongated corrugated member (18) in combination with framework (12) form a symmetrical arched shaped passageway that is ready for final finish by the workman.

It is to be understood that any suitable attachment means of engineering choice may be used for attaching each of the noted ends (30 & 32) onto the support members (26 & 28). For example, the attachment means may be in the form of nails, screws, adhesive, etc. Also, each of the spacers (24) may be fixedly attached in place by any attachment means of choice, such as by adhesive or the like.

As further depicted in FIG. 1, it may be desirable to include bracing bars (34) which provide increased support and strength. However, this is to be determined by the worker at the point of installation, as this is dependant upon the size and shape of the archway.

In some situations the worker may decide to incorporate different options of choice. For example, it may be advantageous to treat each of the spacers (24) with a coating of bug repellent (36) such as depicted in FIG. 2, wherein we show one of the spacers (24) being treated or coated. It is to be understood that each of the spacers (24) can be treated or coated but we only show one herein for clarity purposes. As can be understood the use of bug repellent (36) will prolong the life of the wood and reduce bug infestation and this is very advantageous.

Yet another option may be to include the use of a protective substance of workman's choice applied to each of the spacers (24). For example, in FIG. 2 we show one of the spacers (24) being coated with a protective substance such as lacquer (38) or the like. This option is again very advantageous.

It is to be noted that the present apparatus (10) can be made at the worksite from scrap materials such as corrugated steel and wooden blocks. However, the apparatus may be made at the point of manufacture and produced in various lengths, shapes and/or sizes of engineering choice.

As further depicted in FIG. 1, it can now be seen that after installation of the apparatus (10), the workman is now ready to finish the overall passageway in the normal manner using conventional techniques and conventional materials of workman's choice. For example some conventional materials include, plasterboard, drywall, wood paneling, etc., and is herein represented by (40). It is to be understood that the actual method or steps involved for final finish are not taught herein as such methods and/or steps are very well known within the construction field.

It can now be seen we have herein provided a new and novel apparatus for constructing a very symmetrical arched shaped structure and which can be easily constructed from simple materials, such as a section of corrugated steel and wooden blocks in combination, or the like.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described our invention, what we claim as new and desire to secure by Letters Patent is:

1. An apparatus used for constructing an arched shaped structure within a passageway defined by a framework, said framework comprising: first and second spaced apart vertical stud members which are interconnected by a horizontal header, a first vertical support member fixedly attached onto said first vertical stud and a second vertical support member fixedly attached onto said second vertical stud, said apparatus comprising: an elongated corrugated member having spaced apart upraised ridges which are interconnected by valleys, said valleys each having a fixedly attached spacer therein, said elongated corrugated member with each said spacer in combination when bent form a curved or arched shaped structure having a first end and a second end, said arched shaped structure being positioned in between said first and said second spaced apart vertical stud members, said first end being fixedly attached onto said first vertical support member and said second end being fixedly attached onto said second vertical support member,
whereby:
said elongated corrugated member in combination with said framework form a symmetrical arched shaped passageway which is ready for final finish by a workman.

2. The apparatus of claim 1 wherein said elongated corrugated member is made from a section of corrugated steel.

3. The apparatus of claim 1 wherein each said spacer is made from wood.

4. The apparatus of claim 3 wherein each said spacer is coated with a bug repellent.

5. The apparatus of claim 3 wherein each said spacer is coated with a protective substance.
